(19) United States
(12) Patent Application Publication
(10) Pub. No.: US 2013/0069464 A1
(43) Pub. Date: Mar. 21, 2013

(54) SPINDLE MOTOR AND METHOD FOR MANUFACTURING THE SAME

(71) Applicants: Won Ki Park, Gyunggi-do (KR); Sang Jin Park, Gyunggi-do (KR)

(72) Inventors: Won Ki Park, Gyunggi-do (KR); Sang Jin Park, Gyunggi-do (KR)

(73) Assignee: SAMSUNG ELECTRO-MECHANICS CO., LTD., Gyunggi-do (KR)

(21) Appl. No.: 13/333,025

(22) Filed: Dec. 21, 2011

(30) Foreign Application Priority Data
Sep. 16, 2011 (KR) 1020110093560

(51) Int. Cl. H02K 7/08; H02K 15/00

(52) U.S. Cl. 310/90; 29/596

(57) ABSTRACT

Disclosed herein is a spindle motor including: a rotor including a shaft, a hub, and a magnet; a stator including a sleeve rotatably supporting the shaft, a base having the sleeve coupled thereto, and an armature facing the magnet and including a core and a coil; and a fluid dynamic bearing part formed between the rotor and the stator by being filled with oil, wherein the armature is coupled to an outer peripheral portion of the sleeve.

### CROSS REFERENCE TO RELATED APPLICATION

This application claims the benefit of Korean Patent Application No. 10-2011-0093560, filed on Sep. 16, 2011, entitled “Spindle Motor And Manufacturing Method Of The Same”, which is hereby incorporated by reference in its entirety into this application.

### BACKGROUND OF THE INVENTION

1. Technical Field

The present invention relates to a spindle motor and a method for manufacturing the same.

2. Description of the Related Art

Generally, in a spindle motor used as a driving device of a recording disk such as a hard disk, or the like, a fluid dynamic bearing using dynamic pressure generated by a lubricating fluid such as oil, or the like, stored between a rotor and a stator at the time of rotation of the motor have been variously used.

More specifically, since the spindle motor including the fluid dynamic bearing that maintains shaft rigidity of a shaft only by movable pressure of lubricating oil by centrifugal force is based on centrifugal force, metal friction does not occur and a sense of stability increases as a rotation speed increases, such that the generation of noise and vibration is reduced and a rotating object can be more readily rotated at a high speed than a motor having a ball bearing. As a result, the spindle motor has been mainly applied to a high end optical disk, a magnetic disk device, or the like.

Further, in the spindle motor having the fluid dynamic bearing according to the prior art, it is important to manage a gap between an armature including a core and a coil and a magnet. The management of the gap is determined by management of a height between a base having the armature coupled thereto and a sleeve having a shaft, a hub, and a magnet coupled thereto. Therefore, a defect in the management of the gap may be confirmed after manufacturing of the spindle motor is completed, which causes deterioration in productivity.

In addition, the armature is coupled to an outer peripheral surface of the base facing the magnet, such that it is impossible to attempt to reduce vibration and increase rigidity. Therefore, there is a limitation in implementing stable driving of the spindle motor.

### SUMMARY OF THE INVENTION

The present invention has been made in an effort to provide a spindle motor in which an armature including a core and a coil is coupled to a sleeve of the spindle motor to increase a degree of freedom in design as compared to the spindle motor according to the prior art in which the armature is coupled to the base, such that turns of the coil wound around the core increases, thereby making it possible to improve circuit characteristics, or such that a thickness of a hub increases instead of allowing the turns of the coil wound around the core to be equal, thereby making it possible to improve rigidity.

Further, the present invention has been made in an effort to provide a spindle motor in which an armature including a core and a coil is coupled to an outer peripheral portion of a sleeve, an upper end of the core is fixed to the sleeve, and a lower end of the core is fixed to a base, thereby making it possible to increase rigidity and improve stiffness.

According to a first preferred embodiment of the present invention, there is provided a spindle motor including: a rotor including a shaft, a hub, and a magnet; a stator including a sleeve rotatably supporting the shaft, a base having the sleeve coupled thereto, and an armature facing the magnet and including a core and a coil; and a fluid dynamic bearing part formed between the rotor and the stator by being filled with oil, wherein the armature is coupled to an outer peripheral portion of the sleeve.

The sleeve may include a protrusion part protrudedly formed in order to support an upper end of the core.

The base may include a protrusion support part protrudedly formed in order to support a lower end of the core.

The sleeve may include a groove formed in an upper end thereof facing the hub in order to store and pump a fluid.

The sleeve may include a base insertion part formed therein to face the base, and the base may be insertedly coupled to the base insertion part.

A thickness of an inner diameter of the base may be formed at the base insertion part, and the base may be insertedly coupled to the base insertion part.

According to a second preferred embodiment of the present invention, there is provided a method for manufacturing the spindle motor as set forth above, the method including: insertedly coupling the shaft to the sleeve; insertedly coupling the hub to an upper end of the shaft; coupling the armature including the core and the coil to an outer peripheral surface of the sleeve; and coupling the base to an outer peripheral surface of the sleeve.

The sleeve may include a protrusion part protrudedly formed in order to support an upper end of the core, the upper end of the core may be supported by the protrusion part when the armature is coupled to the outer peripheral surface of the sleeve, the base may include a protrusion support part, and a lower end of the core may be supported by the protrusion support part of the base when the base is coupled to the outer peripheral surface of the sleeve.

### BRIEF DESCRIPTION OF THE DRAWINGS

FIG. 1 is a schematic cross-sectional view of a spindle motor according to a first preferred embodiment of the present invention;

FIG. 2 is a schematic exploded cross-sectional view of the spindle motor shown in FIG. 1;

FIG. 3 is a schematic cross-sectional view of a spindle motor according to a second preferred embodiment of the present invention;

FIG. 4 is a schematic cross-sectional view of a spindle motor according to a third preferred embodiment of the present invention;

FIG. 5 is a schematic cross-sectional view of a spindle motor according to a fourth preferred embodiment of the present invention; and

FIG. 6 is a schematic bottom view of a core and a magnet in the spindle motor shown in FIG. 1.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, a spindle motor and a method for manufacturing the same according to preferred embodiments of the present invention will be described in detail with reference to the accompanying drawings.

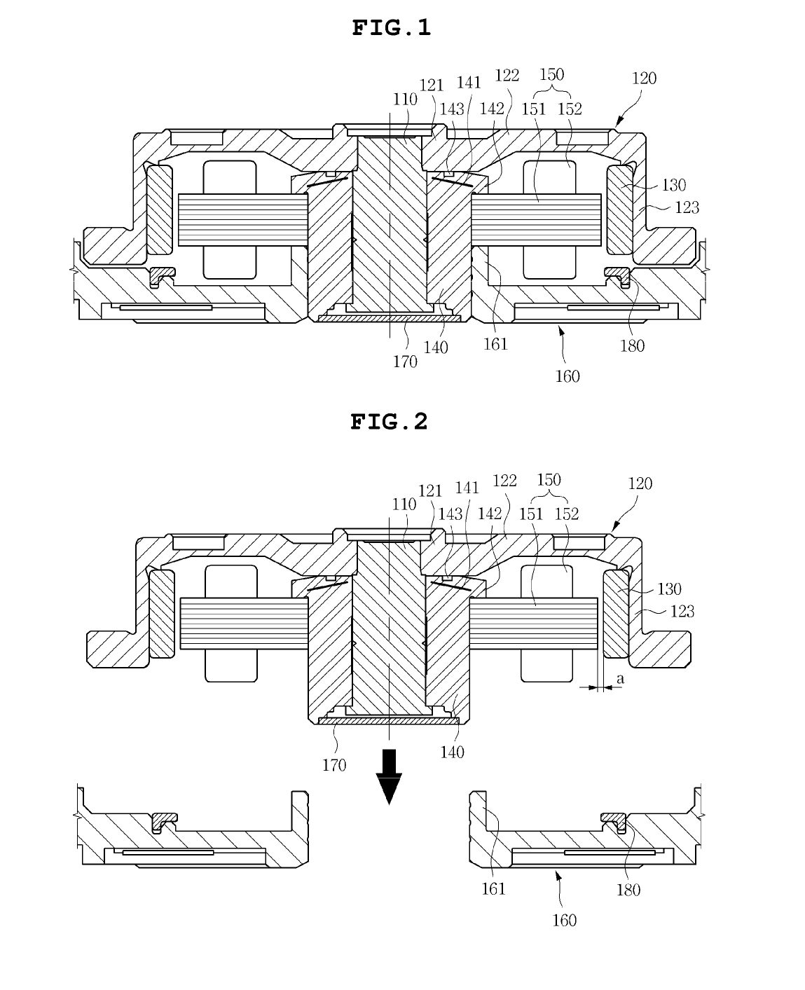

FIG. 1 is a schematic cross-sectional view of a spindle motor according to a first preferred embodiment of the present invention. As shown, the spindle motor 100 is configured to include a rotor including a shaft 110, a hub 120, and a magnet 130; a stator including a sleeve 140, an armature 150, a base 160, a cover 170, and a pulling plate 180; and a fluid dynamic bearing part formed by being filled with oil, which is working fluid.

In the rotor, the shaft 110 includes the hub 120 coupled to an upper end thereof.

In addition, the hub 120 includes a cylindrical part 121 fixed to the upper end of the shaft 110, a disk part 122 extended from the cylindrical part 121 in an outer diameter direction, and a sidewall part 123 extended downwardly from an end of the disk part 122 in the outer diameter direction in an axial direction of the shaft.

In addition, the sidewall part 123 includes an annular ring shaped magnet 130 mounted on an inner peripheral surface thereof so as to face the armature 150 including the core 151 and the coil 152.

Next, in the stator, the sleeve 140 rotatably supports the shaft 110 and is coupled to the base 160.

In addition, the sleeve 140 of the spindle motor 100 according to the preferred embodiment of the present invention includes a dynamic pressure generation groove 141 formed therein so as to face the hub, a protrusion part 142 formed in order to support an upper end of the core coupled to an outer peripheral portion thereof, and a groove 143 formed in an upper end thereof facing the hub in order to store and pump a fluid.

Further, the sleeve 140 includes the armature 150 fixed to the outer peripheral portion thereof by press-fitting, adhesion, or the like, so as to face the magnet 130, wherein the armature 150 includes the core 151 and the coil 152.

In addition, the base 160 includes the sleeve 140 fixed to an inner peripheral portion thereof by press-fitting, adhesion, or the like, and a protrusion support part 161 formed in order to support a lower end of the core 151.

Further, the cover 170, which is to seal the oil injected in order to form the fluid dynamic bearing, is fixedly coupled to an inner peripheral surface of the lower end of the sleeve 140.

In addition, a radial dynamic bearing part (not shown), which is the fluid dynamic bearing part, is formed between the sleeve 140 and the shaft 110. More specifically, the radial dynamic bearing part is formed by forming a micro-gap between the shaft 110 and the sleeve 140 and filling the oil in the micro-gap.

To this end, the radial dynamic bearing part is formed by selectively forming a dynamic pressure generation groove (not show) in an inner peripheral surface of the sleeve 140 or an outer peripheral surface of the shaft 110 facing the inner peripheral surface of the sleeve 140. In addition, the dynamic pressure generation groove may be selectively formed in pair at upper and lower portions of the inner peripheral surface of the sleeve or upper and lower portions of the outer peripheral surface of the shaft.

Further, the pulling plate 180 is positioned to face the magnet 130 in the axial direction and is fixed to the base 160, in order to prevent floating of the hub 120.

FIG. 2 is a schematic exploded cross-sectional view of the spindle motor shown in FIG. 1. As shown, a method for manufacturing the spindle motor 100 according to the preferred embodiment of the present invention includes insertedly coupling the shaft 110 to the sleeve 140; insertedly coupling the hub 120 to the upper end of the shaft 110, coupling the cover 170 to the lower end of the sleeve 140, and coupling the armature 150 including the core 151 and the coil 152 to the outer peripheral surface of the sleeve 140. In addition, the method for manufacturing the spindle motor 100 according to the preferred embodiment of the present invention include coupling the base 160 to the outer peripheral surface of the sleeve 140 so that the protrusion support part 161 of the base 160 supports the lower end of the core 151 of the armature 150.

The armature 150 including the core 151 and the coil 152 is coupled to the sleeve 140 as described above, such that a gap a between the magnet 130 and the core 151 is easily managed. More specifically, as shown as “a” in FIGS. 2 and 6, the gap a may be measured before the base is coupled to the sleeve, in contrast with the spindle motor according to the prior art, such that the gap a may be easily managed.

The upper end of the core 151 is supported by the protrusion part 142 of the sleeve 140 and the lower end of the core is supported by the protrusion support part 161 of the base 160, such that rigidity of a coupling structure may increase, vibration may be reduced, and the motor may be stably driven.

In addition, the armature 150 including the core 151 and the coil 152 is coupled to the sleeve 140, such that a degree of freedom in design may increase as compared to a structure in which the armature is coupled to the base and characteristics of the motor may be improved according to desired specifications. Hereinafter, other preferred embodiments of the present invention will be described in detail.

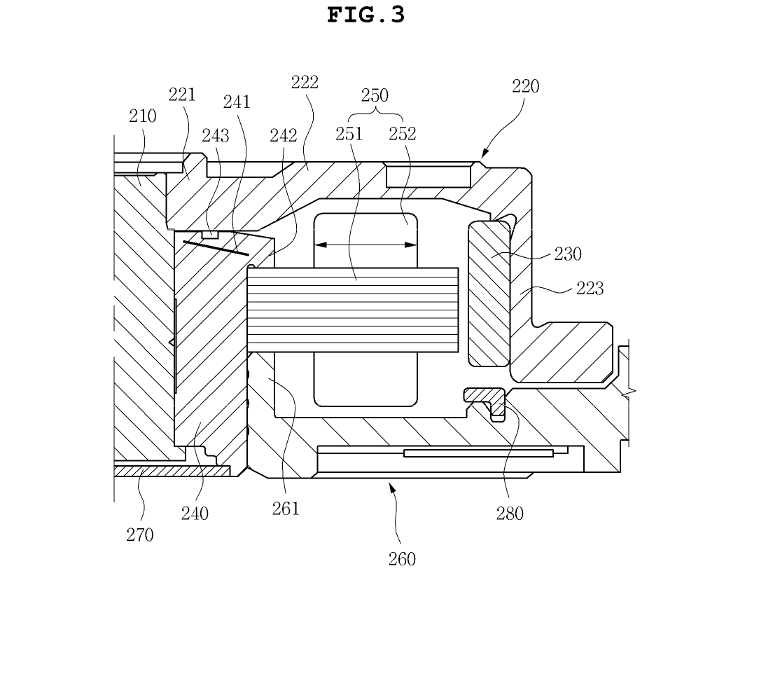

FIG. 3 is a schematic cross-sectional view of a spindle motor according to a second preferred embodiment of the present invention. As shown, in the spindle motor 200, a core 251 is extended to be longer in a circumferential direction, as compared to the spindle motor 100 shown in FIG. 1.

More specifically, the spindle motor 200 is configured to include a rotor including a shaft 210, a hub 220, and a magnet 230; a stator including a sleeve 240, an armature 250, a base 260, a cover 270, and a pulling plate 280; and a fluid dynamic bearing part formed by being filled with oil, which is working fluid.

In addition, the armature 250 includes a core 251 and a coil 252 and is coupled to an outer peripheral surface of the sleeve 240, such that a radial space of the base to which the armature is coupled may be secured as compared to the structure of the spindle motor according to the prior art, that is, the structure in which the armature is coupled to the base and a radial length of the core may be largely secured by the space. As a result, the radial length of the core (shown by an arrow in FIG. 3) is secured, such that turns of the coil 252 wound around the core 251 increase, thereby making it possible to improve circuit characteristics.

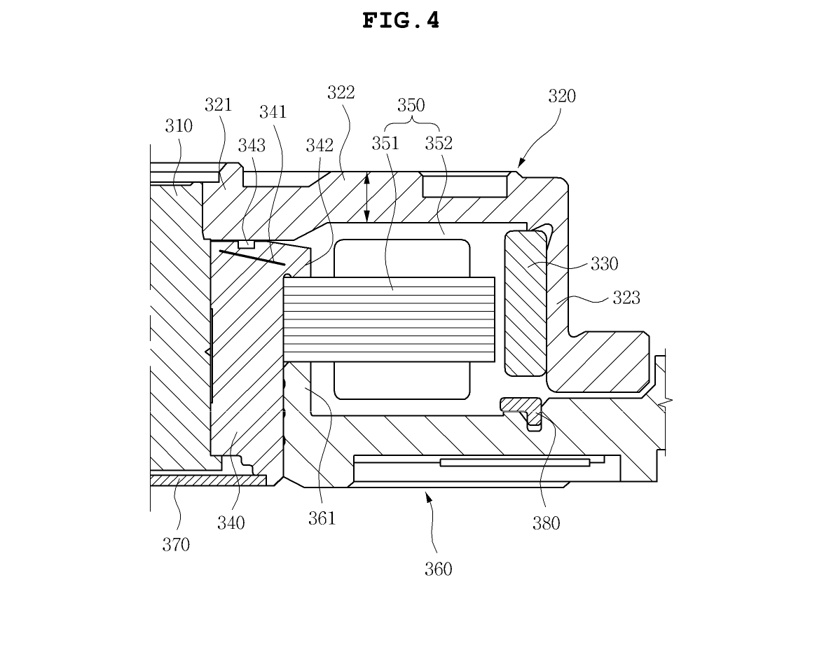

FIG. 4 is a schematic cross-sectional view of a spindle motor according to a third preferred embodiment of the present invention. As shown, in the spindle motor 300, a disk part 322 of a hub is formed to have a thicker thickness, as compared to the spindle motor 100 shown in FIG. 1.

More specifically, the spindle motor 300 is configured to include a rotor including a shaft 310, a hub 320, and a magnet 330; a stator including a sleeve 340, an armature 350, a base 360, a cover 370, and a pulling plate 380; and a fluid dynamic bearing part formed by being filled with oil, which is working fluid.

In addition, the armature 350 includes a core 351 and a coil 352 and is coupled to an outer peripheral surface of the sleeve 340, such that a radial space of the base to which the armature is coupled may be secured as compared to the structure of the spindle motor according to the prior art, that is, the structure in which the armature is coupled to the base and a radial length of the core may be largely secured by the space. As a result, the radial length of the core is secured, such that a thickness (shown by an arror in FIG. 4) of the hub 320 increases instead of allowing turns of the coil 351 wound around the core 351 to be equal, thereby making it possible to improve rigidity.

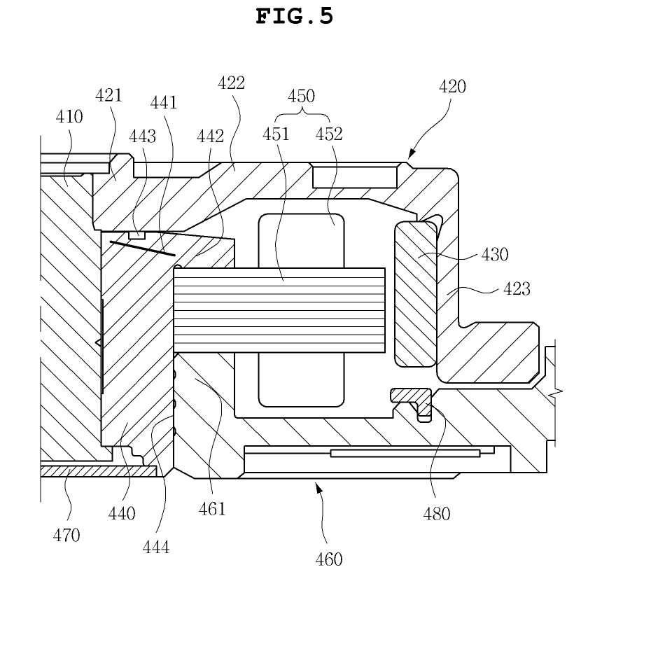

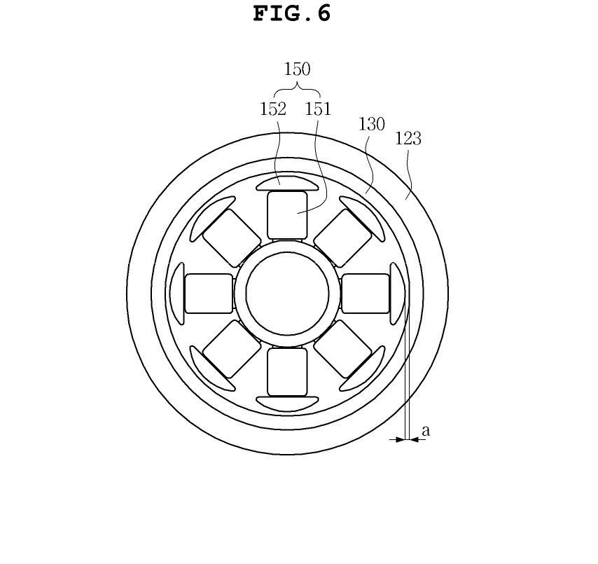

FIG. 5 is a schematic cross-sectional view of a spindle motor according to a fourth preferred embodiment of the present invention. As shown, in the spindle motor 400, a base insertion part is formed in a sleeve, as compared to the spindle motor 100 shown in FIG. 1.

More specifically, the spindle motor 400 is configured to include a rotor including a shaft 410, a hub 420, and a magnet 430; a stator including a sleeve 440, an armature 450, a base 460, a cover 470, and a pulling plate 480; and a fluid dynamic bearing part formed by being filled with oil, which is working fluid.

In addition, the sleeve 440 includes a dynamic pressure generation groove 441 formed therein so as to face the hub 420, a protrusion part 442 formed in order to support an upper end of a core coupled to an outer peripheral portion thereof, and a groove 443 formed in an upper end thereof facing the hub 420 in order to store and pump a fluid. Further, the sleeve 440 includes a base insertion part 444 formed in order to insertedly couple the base 460 thereto. In addition, an inner diameter of the base 460 in which a protrusion support part 461 is formed has a thickness equal to that of the base 160 of the spindle motor 100 according to the first preferred embodiment by the base insertion part 444.

As a result, in the spindle motor according to the fourth preferred embodiment of the present invention, the base 460 is insertedly coupled to the base insertion part 444 of the sleeve 440, such that the spindle motor may be firmly implemented.

According to the preferred embodiments of the present invention, it is possible to obtain a spindle motor in which an armature including a core and a coil is coupled to a sleeve of the spindle motor to increase a degree of freedom in design as compared to the spindle motor according to the prior art in which the armature is coupled to the base, such that turns of the coil wound around the core increases, thereby making it possible to improve circuit characteristics, or such that a thickness of a hub increases instead of allowing the turns of the coil wound around the core to be equal, thereby making it possible to improve rigidity. In addition, it is possible to obtain a spindle motor in which an armature including a core and a coil is coupled to an outer peripheral portion of a sleeve, an upper end of the core is fixed to the sleeve, and a lower end of the core is fixed to a base, thereby making it possible to increase rigidity and improve stiffness.

Although the preferred embodiments of the present invention have been disclosed for illustrative purposes, they are for specifically explaining the present invention and thus a spindle motor and a method for manufacturing the same according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a rotor including a shaft, a hub, and a magnet;
a stator including a sleeve rotatably supporting the shaft, a base having the sleeve coupled thereto, and an armature facing the magnet and including a core and a coil; and
a fluid dynamic bearing part formed between the rotor and the stator by being filled with oil,
wherein the armature is coupled to an outer peripheral portion of the sleeve.

2. The spindle motor as set forth in claim 1, wherein the sleeve includes a protrusion part protrudedly formed in order to support an upper end of the core.

3. The spindle motor as set forth in claim 1, wherein the base includes a protrusion support part protrudedly formed in order to support a lower end of the core.

4. The spindle motor as set forth in claim 1, wherein the sleeve includes a groove formed in an upper end thereof facing the hub in order to store and pump a fluid.

5. The spindle motor as set forth in claim 1, wherein the sleeve includes a base insertion part formed therein to face the base, and the base is insertedly coupled to the base insertion part.

6. The spindle motor as set forth in claim 5, wherein a thickness of an inner diameter of the base is equal to a thickness of the base insertion part, and the base is insertedly coupled to the base insertion part.

7. A method for manufacturing the spindle motor as set forth in claim 1, the method comprising:
insertedly coupling the shaft to the sleeve;
insertedly coupling the hub to an upper end of the shaft;
coupling the armature including the core and the coil to an outer peripheral surface of the sleeve; and
coupling the base to an outer peripheral surface of the sleeve.

8. The method as set forth in claim 7, wherein the sleeve includes a protrusion part protrudedly formed in order to support an upper end of the core, and the upper end of the core is supported by the protrusion part when the armature is coupled to the outer peripheral surface of the sleeve, and
wherein the base includes a protrusion support part, and a lower end of the core is supported by the protrusion support part of the base when the base is coupled to the outer peripheral surface of the sleeve.
